(19) United States
(12) Patent Application Publication
(10) Pub. No.: US 2013/0214116 A1
(43) Pub. Date: Aug. 22, 2013

(54) SEAT POST STRUCTURE

(71) Applicant: MU-RONG LI, Taichung City (TW)

(72) Inventor: MU-RONG LI, Taichung City (TW)

(21) Appl. No.: 13/402,859

(22) Filed: Feb. 22, 2012

(51) Int. Cl. B62J 1/08

(52) U.S. Cl. 248/560

(57) ABSTRACT

A seat post structure includes a seat post having a post body, a middle portion and a top portion, the middle portion connected between the post body and the top portion, the saddle horizontally set onto the top portion, a the supporting slice embedded into the seat post and passing through the top portion and the middle portion therein. Under this arrangement, when a rider is sitting on the saddle and riding on a bumpy road, the top portion, the middle portion and the supporting slice in the seat post are bent slightly by the weight of the rider and the elasticity of the supporting slice provides a recovery force to bend the plank unit, the middle portion and the supporting slice back toward the original position.

### BACKGROUND OF THE INVENTION

1. Field of the Invention

The present invention relates to a seat post and more particularly to a seat post structure which has a shock-absorbing function.

2. Description of Related Art

Bicycle activity is more and more popular in the 21st century because bicycle activity is eco-friendly, convenient and entertaining. Many enterprises encourage their employees to go to work by bicycles instead of driving vehicles today. Many people also go shopping or go traveling by bicycles during their leisure time. When a rider rides a bicycle on a bumpy road, the rider feels shocked and uncomfortable because of the bumpy road. Therefore, how to provide a seat post which can absorb the shock on the bumpy road for making the rider feel comfortable becomes an important topic in the manufacturer's design.

Generally, a conventional seat post structure comprises a seat tube, a seat post, a supporting spring and a positioning assembly. The seat tube encircles the seat post. The seat post is movable axially relative to the seat tube. The supporting spring is set in the seat tube. The top end of the supporting spring abuts against the bottom of the seat post. The bottom end of the supporting spring abuts against the bottom of the seat tube. The positioning assembly is set on the top of the seat tube. The positioning assembly encircles the seat tube and the seat post. The positioning assembly is provided for limiting the range of the axially motion of the seat post. A saddle is assembled on the top of the seat post. Under this arrangement, when the rider rides the bicycle on the bumpy road, the supporting spring in the seat tube can absorb the shock from the bumpy road. However, the conventional seat post structure still has three disadvantages as following:

First, the conventional seat post structure is complicated and has too many pieces to decrease the weight of the bicycle;

Second, it is difficult to maintain the conventional seat post structure because any lost piece can make the conventional seat post broken; and

Third, the manufacturing cost of the conventional seat post structure is higher because of the too many piece needed to be produced.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved seat post structure.

To achieve the objective, a seat post structure comprises a seat post having a post body, a middle portion and a top portion, a central axial line defined along the center the post body, the middle portion connected between the post body and the top portion, one side of the surface of the middle portion being oblique toward the central axial line for connecting to the top portion, the top portion having a plank unit and an arc unit, the lower end of the plank unit of the top portion connected to the middle portion, the plank unit being oblique toward the central axial line, two literal peripheries of the plank unit expanded gradually from the lower end of the plank unit to the top end of the plank unit and the arc unit formed from the top end of the plank unit, the arc unit bent toward the rear end of the saddle to be formed as arc-shaped, the saddle horizontally set onto the central surface of the arc unit, an arc space formed by the arc unit, the plank unit and the middle portion, the arc space opened toward the rear end of the saddle, a supporting slice embedded into the seat post and passing through the plank unit and the middle portion therein, the supporting slice corresponding to the plank unit defined as a flat portion, the supporting slice corresponding to the middle portion defined as an arc portion, the flat portion connected to the arc portion, the supporting slice having elasticity and supporting the weight of the rider who is sitting on the saddle, the flat portion and the arc portion both close to one side of the central axial line, one end of the arc portion gradually bent over the central axial line. Wherein, the seat post is made from fiber complex materials; the supporting slice is made of metal; a protruded portion is defined between the plank unit and the post body; the protruded portion is opposite to the middle portion; the arc unit has two through holes; the two through holes are parallel alignment; each through hole is defined from one end of the arc unit to another end of the arc unit.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a seat post structure of the present invention;

FIG. 2 is a perspective view of the seat post structure for showing a supporting slice;

FIG. 3 is a cross-sectional view along the line AA of FIG. 1 for showing the relationship between a post body, a middle portion, a top portion and the supporting slice;

FIG. 4 is an assembled view for showing a saddle which is assembled to the seat post structure;

FIG. 5 is a side view for showing a rider who is setting on the saddle when the supporting slice is not bent yet; and

FIG. 6 is a side view for showing the rider who is setting on the saddle when the supporting slice has been bent already.

### DETAILED DESCRIPTION OF THE INVENTION

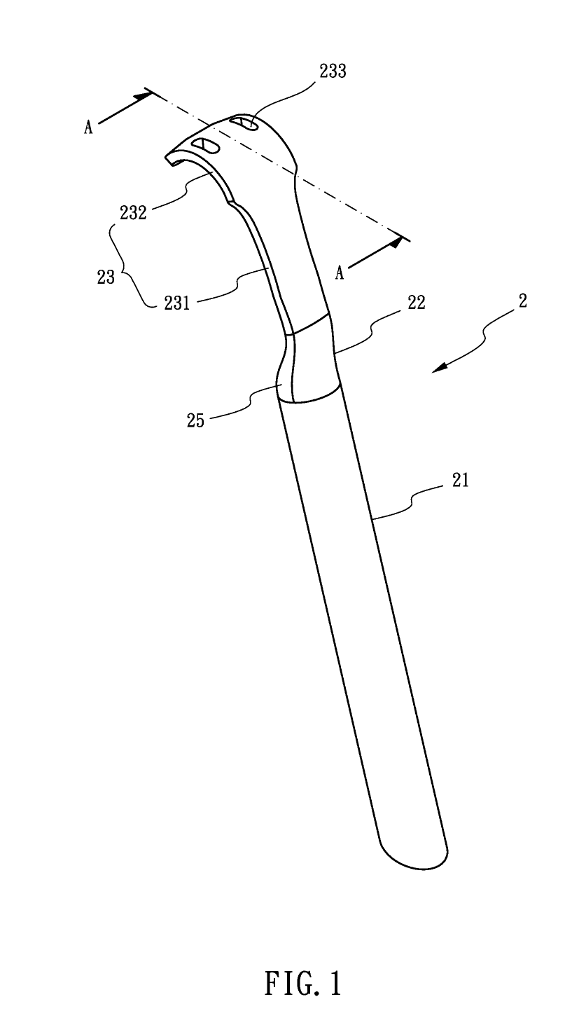

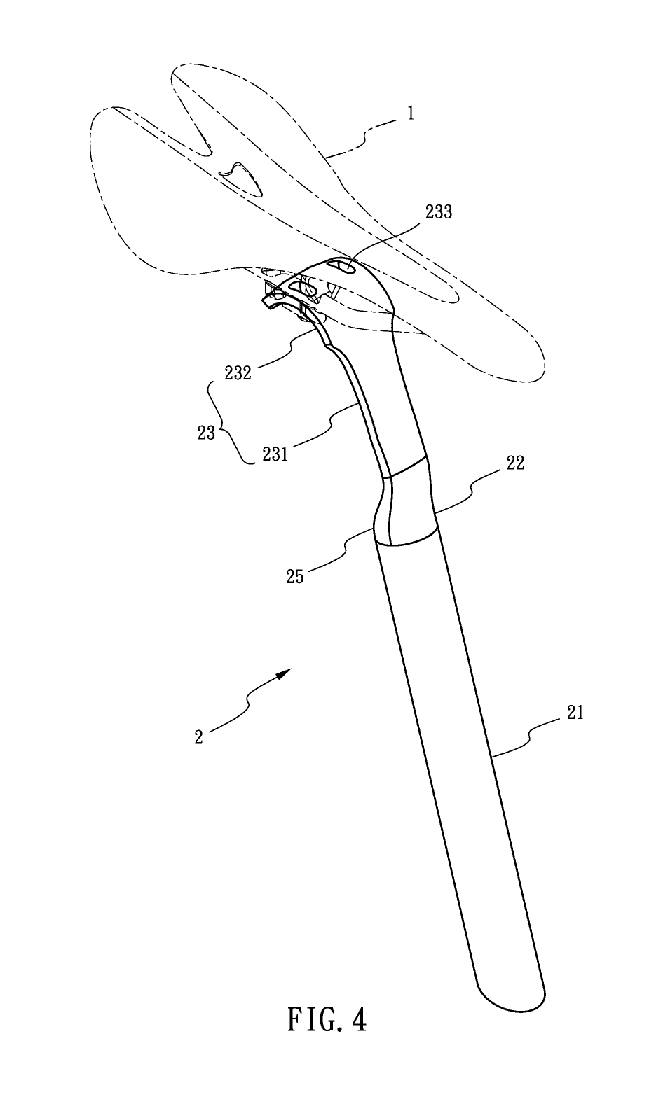

Referring to FIGS. 1-4, a seat post structure in accordance with the present invention is assembled to the bottom of a saddle 1 for supporting the weight of a rider who is sitting on the saddle 1. The seat post structure comprises a seat post 2 and a supporting slice 3. The seat post 2 has a post body 21, a middle portion 22 and a top portion 23. A central axial line 211 is defined along the center the post body 21. The middle portion 22 is connected between the post body 21 and the top portion 23. One side of the surface of the middle portion 22 is oblique toward the central axial line 211 for connecting to the top portion 23. The top portion 23 has a plank unit 231 and an arc unit 232. The lower end of the plank unit 231 of the top portion 23 is connected to the middle portion 22. The plank unit 231 is oblique toward the central axial line 211. Two literal peripheries of the plank unit 231 are expanded gradually from the lower end of the plank unit 231 to the top end of the plank unit 231. Thereafter, the arc unit 232 is formed from the top end of the plank unit 231. The arc unit 232 is bent toward the rear end of the saddle 1 to be formed as arc-shaped. The saddle 1 is horizontally set onto the central surface of the arc unit 232 (as shown in FIG. 4). An arc space 24 is formed by the arc unit 232, the plank unit 231 and the middle portion 22. The arc space 24 is opened toward the rear end of the saddle 1. The supporting slice 3 is embedded into the seat post 2. The supporting slice 3 passes through the plank unit 231 and the middle portion 22 therein. The supporting slice 3 corresponding to the plank unit 231 is defined as a flat portion 31. The supporting slice 3 corresponding to the middle portion 22 is defined as an arc portion 32. The flat portion 31 is connected to the arc portion 32. The supporting slice 3 is made of metal in this embodiment. The supporting slice 3 has elasticity and supports the weight of the rider who is sitting on the saddle 1. The flat portion 31 and the arc portion 32 are both close to one side of the central axial line 211. One end of the arc portion 32 is gradually bent over the central axial line 211.

The above description is enough to perform preferred functions in the embodiment of the present invention.

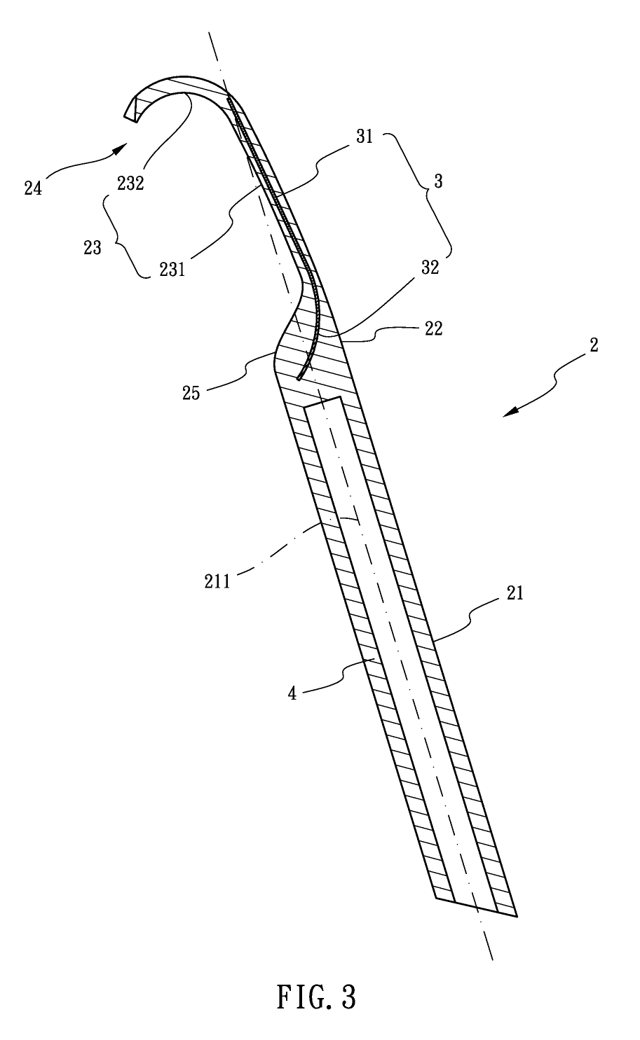

Furthermore, the seat post 2 is made from fiber complex materials 4 for lightening the whole weight of a bicycle with the seat post structure (as shown in FIG. 3). The arc unit 232 has two through holes 233. The two through holes 233 are parallel alignment. Each through hole 233 is defined from one end of the arc unit 232 to another end of the arc unit 232. The through hole 233 is used to assemble the saddle 1 on the arc unit 232. A protruded portion 25 is defined between the plank unit 231 and the post body 21. The protruded portion 25 is opposite to the middle portion 22. The protruded portion 25 is used to strengthen the connection between the post body 21 and the top portion 23 so as to support the rider with more weight and prevent the top portion 23 from broken.

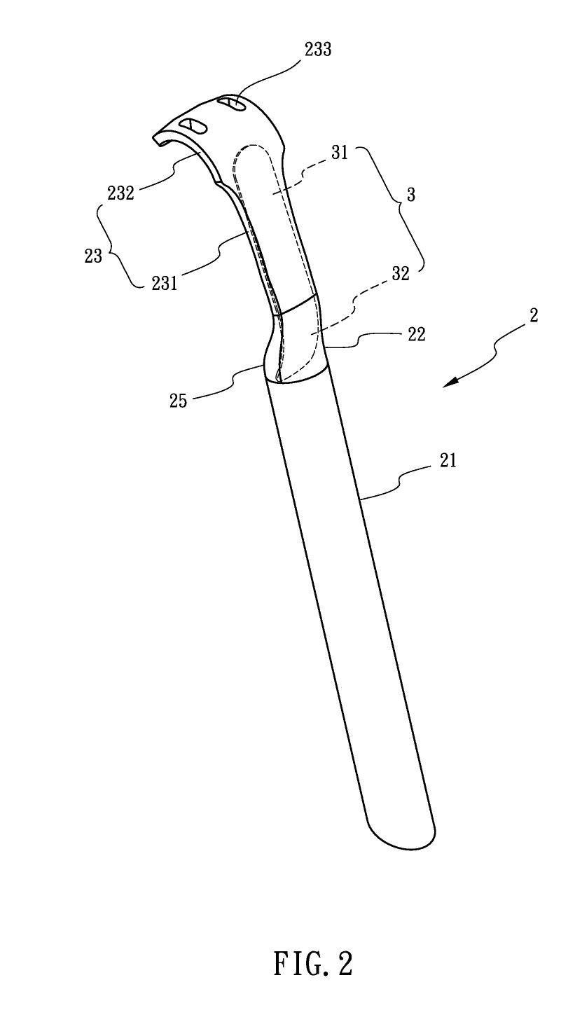

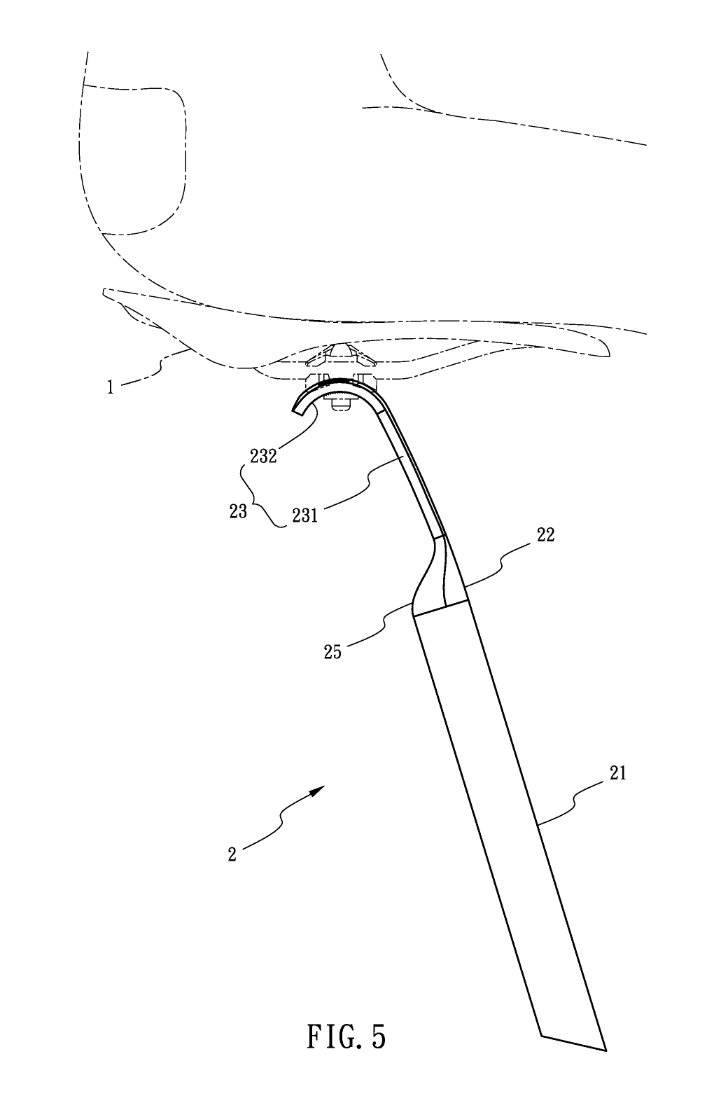

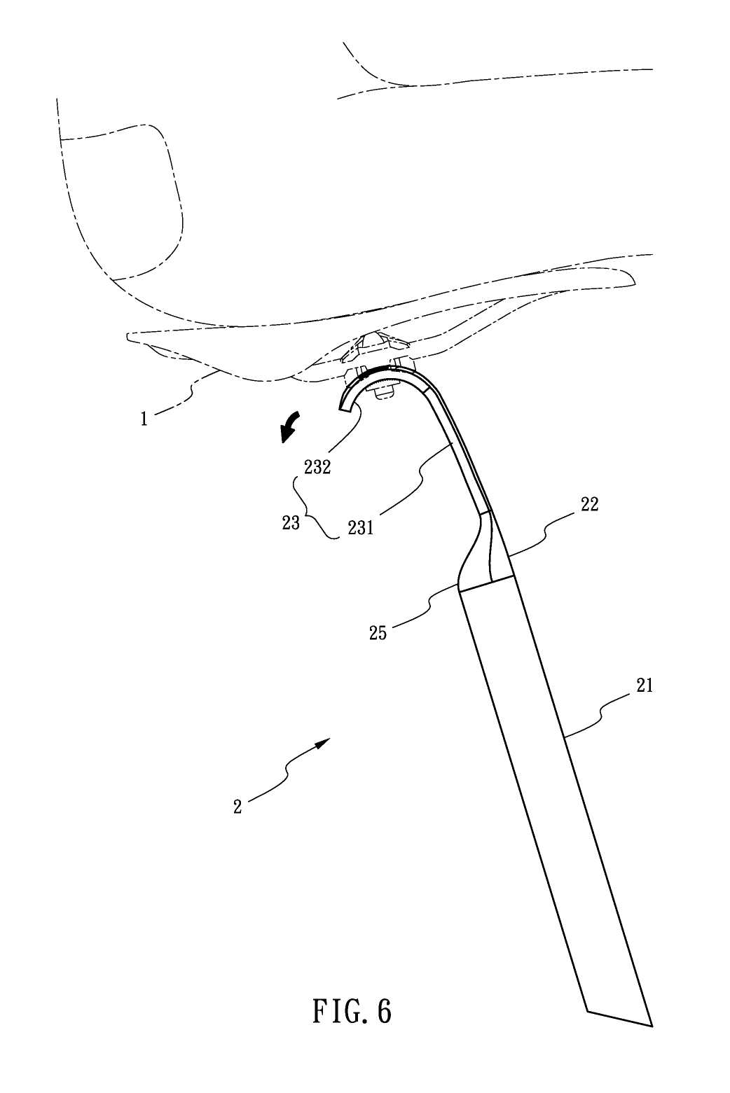

Referring to FIGS. 2-3 and FIGS. 5-6, when the rider is sitting on the saddle 1 and riding on a bumpy road, the plank unit 231, the middle portion 22 and the supporting slice 3 in the seat post 2 are bent slightly by the weight of the rider and the elasticity of the supporting slice 3 provides a recovery force to bend the plank unit 231, the middle portion 22 and the supporting slice 3 back toward the original position. Therefore, the supporting slice 3 not only prevents the plank unit 231 and the middle portion 22 from breaking but also provides a shock-absorbing function for the rider when the rider rides on the bumpy road.

Although the invention has been explained in relation to its preferred embodiment, it is to be understood that many other possible modifications and variations can be made without departing from the spirit and scope of the invention as hereinafter claimed.

1-5. (canceled)

6. A seat post structure for a bicycle, the structure comprising:
a tubular post body;
a joint portion made of a fiber complex material and extending from a top end of the post body;
a top portion made of a fiber complex material and including a first plate section and a second plate section extending from a top end of the first plate section; the first plate section substantially disposed on one side of a central axis of the post body and being substantially flat at an oblique angle relative to the central axis of the post body from the top end adjacent to the central axis of the post body to a bottom end joined to the joint portion; the second plate section substantially disposed on an opposite side of the central axis of the post body and having an arc-shaped cross section with a top surface for connection to a bottom of a saddle of the bicycle; and
a supporting sheet embedded in the joint portion and through the first plate section of the top portion, being made of metal to strengthen the top portion, and having an elasticity to provide a restoring force once the top portion is bent.

7. The seat post structure of claim 6, wherein the second plate section of the top portion is arch-shaped and has at least one slot defined in a center of the second plate section; and the slot of the second plate extending in a direction parallel to the arc-shaped cross section to facilitate position adjustment of the saddle relative to the second plate section.

8. The seat post structure of claim 6, wherein the first plate section of the top portion is gradually enlarged from bottom to top.

9. The seat post structure of claim 6, wherein the supporting sheet has a flat section disposed in the first plate section and an arc section extending from the flat section and disposed in the joint portion.
